(19) United States
(12) Patent Application Publication
(10) Pub. No.: US 2015/0161555 A1
(43) Pub. Date: Jun. 11, 2015

(54) SCHEDULING TASKS TO OPERATORS

(71) Applicants: Ming Cui, Sunnyvale, CA (US); Cheng Xu, Sunnyvale, CA (US)

(72) Inventors: Ming Cui, Sunnyvale, CA (US); Cheng Xu, Sunnyvale, CA (US)

(73) Assignee: GOOGLE INC., Mountain View, CA (US)

(21) Appl. No.: 13/545,825

(22) Filed: Jul. 10, 2012

(51) Int. Cl. G06Q 10/06

(52) U.S. Cl. CPC G06Q 10/063118

(57) ABSTRACT

Tasks are assigned to operators for performing the tasks during a work period, for example, a shift. A model is generated for predicting the time taken by operators for completing a given task. A mapping from a subset of tasks to the operators is determined so as to maximize a total value of tasks from the subset. The tasks are assigned to operators based on the mapping. An example of tasks assigned to operators is fixing of defects identified in business listings associated with maps. The defects are associated with value determined based on various factors including the location of the business, the number of times the business listing is requested, the number of times the defect was reported, or the type of information in the business listing that is incorrect.

### FIELD OF THE INVENTION

This invention relates in general to scheduling to maximize the number of tasks completed by operators during a period, and in particular to optimal scheduling of task related to business listing errors.

### BACKGROUND

Online map service providers allow users to view maps online, for example, to locate an address, to find directions, view street maps, traffic information and the like. A map presents a visual representation of a region displaying geographical information along with other information, for example, information describing rivers, hills, parks, trails, streets, highways, railroad networks, and the like. The additional information often includes business listings associated with locations. For example, a user requesting a map of a location is presented with information describing businesses near the location. A business listing can include information describing the business including name of business, phone numbers, address, website, services offered, hours of business, and the like.

However, information describing businesses often changes over time as new businesses open, existing businesses relocate, close down, or change their information, for example changing their hours, website, or services offered. In these cases, there will be errors in the map due to the discrepancy between the information presented in the map and the actual information of the business. Errors in maps can also be caused due to other reasons, for example, due to data entry errors or due to changes in a region over time as new highways, streets or buildings are constructed.

Map service providers often allow users to report discrepancies that they notice in a map. For example, a user who notices an incorrect business listing in a map can report the error via a user interface of the map service provider. Similarly, a user may notice that a street shown on the map has been renamed or a street shown on the map no longer exists and report these. A popular map service with a large number of users may receive a large number of user reported errors. The map service provider may use the services of human operators to get the reported errors verified and fixed. Efficiently resolving a large number of business listing errors with the help of operators is a challenging problem since several factors need to be considered while scheduling these tasks. These factors include types of map errors, expertise of individual operators, shifts during which particular operators work, and the like.

### SUMMARY

Computer-implemented methods, computer systems, and computer program products assign of tasks to operators for completion during a work period. In one embodiment, the system receives a set of pending tasks and a set of operators for performing tasks in a work period, for example, a shift. The system predicts an amount of time required by each operator to complete the task using a model trained with historical data describing tasks previously completed by members of the set of operators. The system determines a mapping from a subset of the pending tasks to operators such that each task is associated with an operator for performing the task during the work period. Each task may be associated with a value and the subset is selected to maximize the total value of the subset of tasks, using the predicted completion times from the various operators. The system assigns the tasks to the associated operators for completion during the work period and stores information describing the assigned tasks and the associated operators.

In some embodiments, each model may be trained using historical data specific to a particular operator whereas in other embodiments, a model may be trained using historical data describing a set of operators, for example, a model representing a category of operators or single model representing the entire set of operators. In an embodiment, each task comprises fixing a defect associated with a business listing displayable on a map. The value of each task can be determined based on various factors, for example, urgency of the task, a click through rate of a web page associated with the business listing of the task, the number of times the defect specified in the task was reported, the density of population of the location of the business associated with the task, or a rate at which the business listing is requested by users. In an embodiment, the subset of the pending tasks is determined by formulating a generalized assignment problem that maps items to bins, each item associated with a profit value.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level diagram showing a system environment for allowing users and operators to interact with a mapping system according to an embodiment of the invention.

FIG. 2 is a screenshot of a user interface presented to an operator for managing tasks associated with the operator according to an embodiment of the invention.

FIG. 3 is a high-level block diagram illustrating a detailed view of modules within a mapping system that schedules tasks among operators according to an embodiment of the invention.

FIG. 4 shows a data flow diagram illustrating the data flow for training operator models for predicting completion time for tasks, according to one embodiment of the invention.

FIG. 5 shows a data flow diagram illustrating the interaction between various types of data stored in the mapping system for assigning tasks to operators, according to one embodiment of the invention.

FIG. 6 shows a flowchart illustrating the process of assigning tasks to operators, according to one embodiment of the invention.

FIG. 7 is a high-level block diagram illustrating an example of a computer for use in the computing environment shown in FIG. 1 according to one embodiment of the present disclosure.

The figures and the following description describe certain embodiments by way of illustration only. One skilled in the art will readily recognize from the following description that alternative embodiments of the structures and methods illustrated herein may be employed without departing from the principles described herein.

### DETAILED DESCRIPTION

### Introduction

A mapping system utilizes services of human operators to fix defects in online maps. An operator performs various types of actions to verify or fix a map defect. For example, if an incorrect business listing is associated by the mapping system with an address, an operator may perform internet searches to identify the correct listing and fix the defect. For some types of defects the operator may make phone calls to verify or obtain new information. For some other defects the operator may lookup information using various sources, for example, yellow pages, white pages, and the like.

Each operator may have expertise in one or more types of problem solving techniques. For example, some operators may be experts at making phone calls whereas others may be experts at performing internet searches. Each task can be associated with the types of actions that need to be performed to complete the task. For example, certain types of map defects may require making phone calls to fix the defect whereas others may require internet search. An operator is likely to perform a task inefficiently if the operator does not have the expertise required for the task. Therefore, each task should be matched with an operator having the skills required for performing the task in order to complete the task most efficiently. In general, the efficiency of an operator can be measured by the amount of time taken to complete a task.

Embodiments generate machine-learned models for predicting time taken by operators for performing a given task. The models are trained using historical data describing time taken for operators to perform different types of tasks in the past. In one embodiment, a model is trained for each individual operator. Given a task to be completed, the individual models of the various operators predict the amount of time necessary for each operator to complete the task. In another embodiment, a machine learned model is trained for categories of operators, each category comprising a set of operators with similar attributes. Each operator is characterized by a set of attributes and mapped to a specific category based on the set of attributes. The model corresponding to the category of an operator is used to predict (equivalently, estimate) the time required by the operator to complete a task. In another embodiment, a single model is used to predict the time taken by any operator, regardless of attributes, to complete a task.

Given a set of tasks, the models are used to determine a mapping from tasks to operators. The mapping from tasks to operators is determined by representing the task scheduling problem as a generalized assignment problem. The generalized assignment problem maps items (here, tasks) to bins where each bin is associated with an operator and has a capacity representing the total amount of time that the operator has available to work on tasks. Each item is associated with a profit value. The generalized assignment problem determines a subset of items that can be assigned to the various bins within their capacity such that the subset maximizes the profit value.

### System Environment

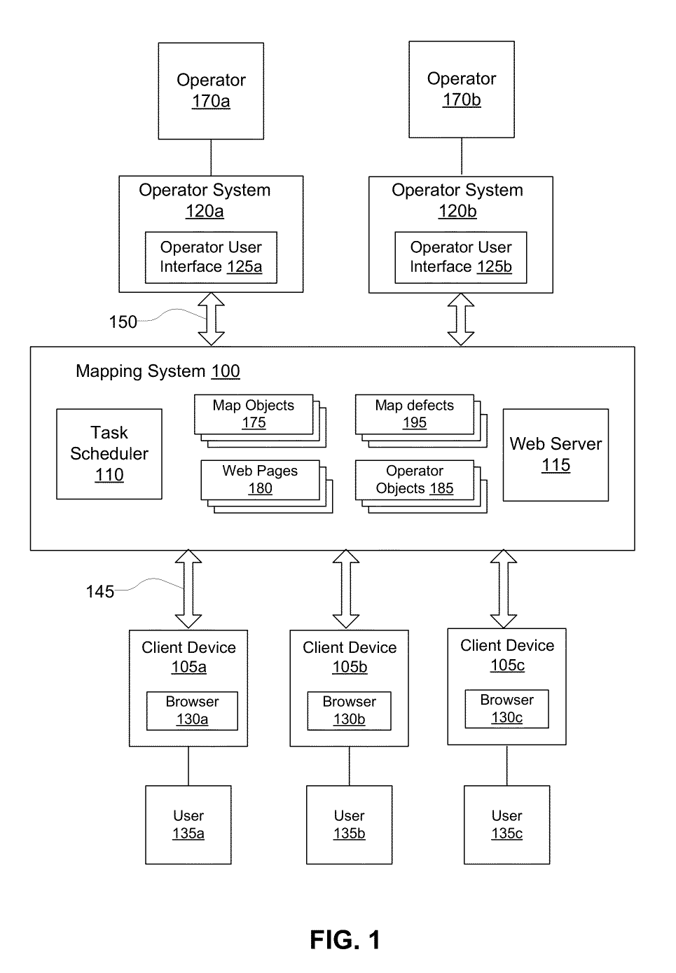

FIG. 1 is a high-level diagram showing a system environment for allowing users and operators to interact with a mapping system according to one embodiment. The mapping system 100 provides maps and map related services to users 135 of the client devices 105. (A letter after a reference numeral, such as “130a,” indicates that the text refers specifically to the element having that particular reference numeral, while a reference numeral in the text without a following letter, such as “130,” refers to any or all of the elements in the figures bearing that reference numeral.) In an embodiment, the mapping system 100 is a website with which users 135 can interact using a browser 130 running on a client device 105. The users can interact with the mapping system 100 to view maps and utilize map related services offered by the mapping system 100. The users can also interact with the mapping system 100 to provide information regarding defects in map data provided by the mapping system 100.

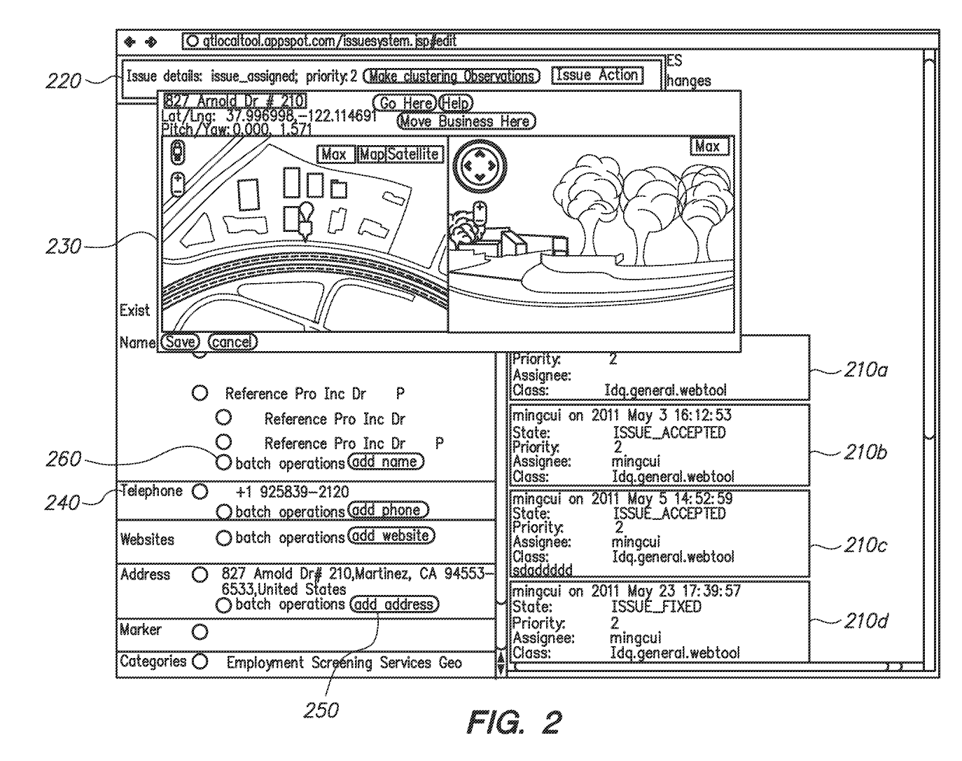

The mapping system 100 allows operators 170 to interact with the mapping system 100 using operator systems 120 to fix defects. An operator system 120 includes an operator user interface 125 that allows operators 170 to manage their tasks. An example screenshot of the operator user interface 125 is shown in FIG. 2 and described below. Although the methods herein describe the example of a mapping system, the methods can be extended to other types of computer systems that schedule tasks among operators.

The mapping system 100 stores objects representing various types of information including, map objects 175, web pages 180, map defects 195, and operator objects 185. A map object 175 represents information describing maps and may include map data along with related information including satellite images, business information, or street images. A web page 180 may be dynamically generated in response to a web request from a client device 105. A map defect 195 represents information describing a defect in the map data and may include a location associated with the defect, a description of the defect, information describing the user 135 (or users) who filed the defect with the mapping system 100. The mapping system 100 assigns a task to an operator 170 to fix the defect. The operator objects 185 represent an operator 170 and information describing the operator 170, for example, languages spoken by the operator, any specializations of the operator, the level of experience and expertise of the operator, and past historical information of the operator.

Each type of object stores information describing a particular entity and may refer to other objects. For example, a map defect 195 is used to represent the defect itself and may refer to an operator object 185 corresponding to an operator 170 assigned to fix the defect, thereby representing the task of fixing the defect. A web page 180 may refer to a map object 175. Similarly, a map defect 195 may refer to a map object 175 representing the map for which the defect has been specified.

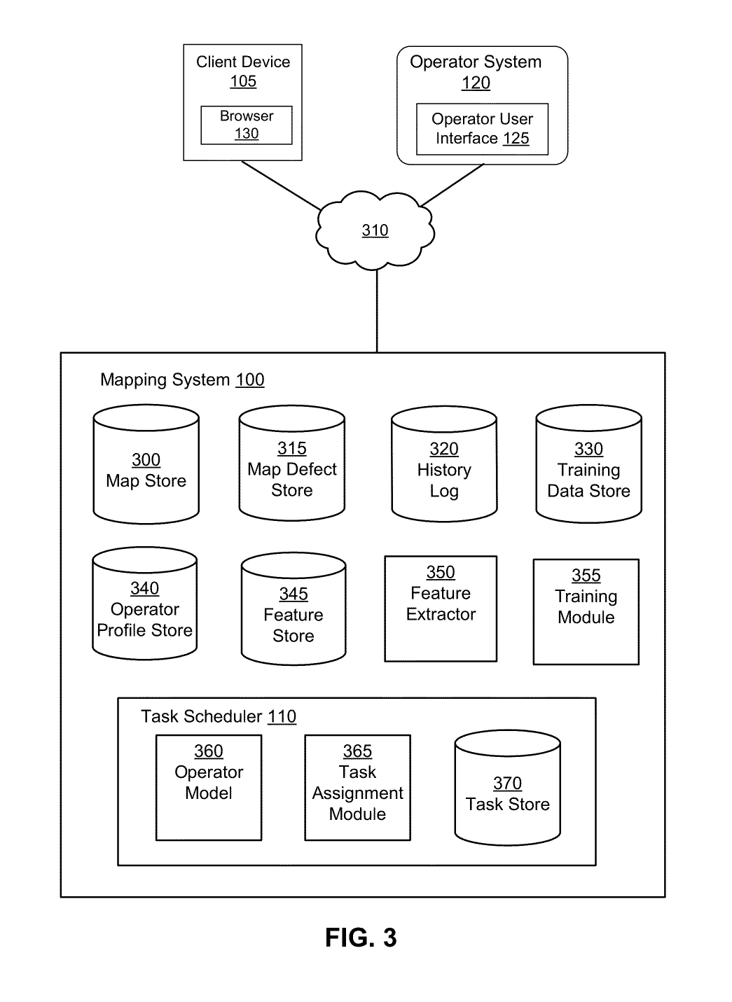

The mapping system 100 includes a task scheduler 110 that assigns tasks to operators. An example of a task is fixing a defect. In one embodiment, the task scheduler 110 schedules tasks for a given period so as to maximize the number of tasks fixed during the period. In another embodiment, each task is further associated with a value representing a significance of fixing the task and the task scheduler schedules tasks so as to maximize the total value associated with the tasks scheduled for a given period. The value can be a figure of merit, and represent any combination of factors, such as an amount of time to fix the defect, a monetary value associated with fixing the defect, a measure of importance in fixing the defect, a measure of priority for fixing the defect, the age of the defect, the source of the defect, the location of the defect, and so forth. A period of time can be a shift or a day during which operators work. In an embodiment, the task scheduler 110 predicts the amount of time needed by each operator to complete a task based on models developed using machine learning techniques. The task scheduler 110 may comprise other components as described with respect to FIG. 3, below.

In an embodiment, the mapping system includes a web server that allows external systems, including client devices 105 and operator systems 120 to send hyper text transfer protocol (HTTP) requests. The mapping system 100 responds to the requests by generating an appropriate web page 180 and sending to the requestor. For example, if a client device 105 sends a request for a map of a given address, the mapping system 100 responds by generating a web page 180 including information describing the map. For example, the web page provided to the client device includes an image representing a map of the geographical region around the address. In other embodiments, the operator systems 120 and/or client devices 105 may execute client applications that communicate with the mapping system 100 using other communication mechanisms, for example, proprietary communication protocols.

Client devices 105 are computing devices that execute client software, e.g., a web browser 130 or built-in client application, to interact with the mapping system 100 via a network. The client device 105 might be, for example, a personal computer, a personal digital assistant, a cellular, mobile, or smart phone, a laptop computer, a television “set-top box,” and the like. Note that the terms “client,” “client device,” “operator” and “operator system” as used herein may refer to software providing respective functionality, to hardware on which the software executes, or to the entities operating the software and/or hardware, as is apparent from the context in which the terms are used.

FIG. 2 is a screenshot of a user interface presented to an operator for managing tasks according to an embodiment of the invention. As shown in FIG. 2, an operator can view a list of various tasks 210 along with brief description of each task. The brief description of a task lists attributes describing the task including, an assignee identifying the operator to whom the task is assigned, a priority of the task, a class of the task, and the state of the task describing whether the task is assigned, unassigned, accepted, fixed etc. In an embodiment, the operator can search for various tasks based on specific criteria, for example, all tasks assigned to a particular operator or all tasks in a particular state. The operator may be allowed to search using combinations of attribute values, for example, all tasks assigned to a particular operator belonging to a particular class.

The operator can use the user interface to view details 220 of a particular task. The details of the task presented can include visual representation of the map associated with the task. The details of a task can also include a detailed description 240 of various attributes of the task, for example, name of the business, address of the business, an address of a website associated with the business, telephone numbers of the business and the like. The user interface may allow the operator to edit the information, for example, user interface elements 250 allow the operator to add attribute values, update attribute values or delete attribute values. The user interface shown in FIG. 2 allows operators to perform batch operations 260 by specifying information related to multiple inputs, for example, phones, addresses, or categories as a single operation.

As should be apparent from the foregoing, the methods and operations described here, and in particular those related to the creation of models for predicting operator time and the use of such models in assigning tasks to operators require an implementation by computer programming on a computer system, and cannot be performed entirely by mental steps in the human mind. While a human user may input certain data and observe certain results, the computer system performs all of the data processing and data analysis steps described herein.

### Architectural Overview of Job Scheduler

FIG. 3 is a high-level block diagram illustrating a detailed view of modules within a mapping system that schedules tasks among operators according to an embodiment of the invention. The mapping system 100 communicates with external systems including client devices 105 and operator systems 120 using the network 310. The network 310 is typically the Internet, but may be any network, including but not limited to a LAN, a MAN, a WAN, a mobile wired or wireless network, a private network, or a virtual private network. In one embodiment, the network 310 uses standard communications technologies and/or protocols. For example, the networking protocols used on the network 310 can include the transmission control protocol/Internet protocol (TCP/IP), the hypertext transport protocol (HTTP), the file transfer protocol (FTP), etc. The data exchanged over the network 310 can be represented using technologies and/or formats including the hypertext markup language (HTML), the extensible markup language (XML), etc. In some embodiments, the entities can use custom and/or dedicated data communications technologies instead of, or in addition to, the ones described above.

The mapping system 100 includes a map store 300, a map defect store 315, history log 320, training data store 330, operator profile store 340, operator feature store 345, feature extractor 350, training module 355, and task scheduler 110. Some embodiments of the mapping subsystem 100 have different and/or other modules than the ones described herein, and the functions can be distributed among the modules in a different manner than is described here. For example, while FIG. 3 shows a single mapping subsystem 100 including modules for map store 300, operator profile store 340, map defect store 315, and training data store 330, in an embodiment these stores may be available in separate systems that communicate with each other for exchange of information.

Other conventional features, such as firewalls, load balancers, authentication servers, application servers, failover servers, site management tools, and so forth are not shown so as to more clearly illustrate the features of the mapping system 100. The illustrated components of the mapping system 100 can be implemented as a combination of hardware and software. In general, functions described in one embodiment as being performed by one component can also be performed by other components in other embodiments, or by a combination of components.

The operator profile store 340 stores information describing various operators. In one embodiment, the operator profile store stores information identifying the operators, along with attributes describing the operators. In an embodiment, the information describing an operator is represented as a vector of scores, each score indicating the level of expertise of the operator for a particular type of tasks. For example, a vector describing an operator can be (0, 5, 10, 0, . . . ) in which each value is a score out of 10. For example, the first element of the vector can be a score indicating the level of expertise of the operator in performing internet searches. The value of 0 may indicate that the operator has no expertise in performing internet searches to research an issue. The second element may indicate a level of expertise in performing a particular database lookup. A score of 5 may indicate an average level of expertise. The third element of the vector may indicate the level of expertise of the operator in making phone calls. The value of 10 may indicate the operator is an expert at making phone calls. Other information stored in an operator profile may describe shifts that the operator works, a location of the operator, the operator's time zone, languages the operator speaks, and the like.

The map store 300 stores information describing maps. The map information may be stored in a particular format, for example, vector format or raster format. The map store 300 may include other information related to maps including satellite images, business information, or street images. In an embodiment, the mapping system 100 receives a request for a map of a location and renders an image of a map for the location, which it provides in response to the request. The mapping system 100 may use the information stored in the map store 300 to provide map related services, for example, directions or traffic information.

A business listing stored in the map store 300 can be associated with a significance score indicating a level of importance associated with the business listing. The significance score of a business listing may be determined based on various factors including a click through rate of a web page associated with the business listing when it is presented as a search result, a number of user complaints about the listing, and the geolocation of the business listing. For example, a business listing in a heavily populated area, for example, the business district of San Francisco may be determined to have a higher significance score that a business listing in a small town. Similarly, a business listing that has multiple complaints about the listing may be assigned a higher significance score since more people have encountered the defect associated with the business listing.

The map defect store 315 stores information describing defects associated with maps. The defects stored in the map defect store 315 may comprise a description of the problem, a reference to a map object 175 associated with a problem, and a reference to a business listing for which the defect was reported. If available, information describing the user (or users) who reported the defect may be stored along with each defect. A map defect may be associated with a priority indicating a level of urgency for fixing the defect. For example, a defect for a business listing that is retrieved very frequently may be assigned higher priority than a defect for a business listing that is rarely retrieved. The priority associated with the defect may also depend on the type of defect. For example, an error in the address of a business listing may be assigned higher priority than an incorrect phone number for the business listing. A map defect may be also associated with the number of times the defect has been reported. The priority of a defect may be increased if the same defect is being reported multiple times by different users. These attributes (e.g., priority, importance, etc.) may be used to determine the value in fixing a defect for a business listing, as further described below.

The mapping system 100 further comprises a history log 320 that stores a record of defects filed by users, defects assigned to operators, defects fixed by operators, and any associated events or statistics. For a defect, the history log 320 stores a date and time when a defect was reported, the date and time when the defect was fixed, an identifier (e.g., a unique username) of the operator who fixed the defect, the location of the defect, one or more maps associated with the defect, and metadata describing the action taken to correct the defect. The history log 320 may, for convenience of later computations, store aggregated information (e.g., summations, counts, averages, variances, rates, and so forth) for either individual tasks, or across multiple tasks, that is derivable from other data within the log, such as a total number of tasks completed, count of various types of tasks, average completion time for different types of tasks, and so on, whether by operator or group of operators, by shift, by task type, defect type, and so forth.

The training module 355 obtains training data from the history logs 320 and stores the training data in the training data store 330. The training data store 330 stores training sets comprising tuples, each tuple including information identifying an operator, a map defect, and the time taken by the operator to fix the map defect. The training module 355 trains a machine learning model for each operator or for groups of operators sharing similar attributes using the data from training data store 330. The resulting operator model 360 predicts the amount of time taken to fix a given defect by an operator. The operator model 360 can be a least square regression model. In other embodiments, the operator model can be a tree-based model, kernel method, neural network, or ensemble of one or more of these techniques.

The feature extractor 230 extracts various features of map defects that characterize the map defects. Features of map defects may describe a type of information that is incorrect in a map, for example, the type of business listing information that is incorrect. These may include a phone number, an address, a physical location, web address or business hours of the business listing. In an embodiment, the feature extractor 230 represents various features describing a map defect as a vector of values. Certain rules may be specified, for example, by experts for deriving values of certain attributes of the defect vector given other attribute values. The feature extractor 230 may utilize these rules to infer values of certain attributes of the defect vector. Specific rules may be triggered when specific attribute values are available. In this situation, the rule is applied when triggered to derive certain values which are subsequently stored in the vector that describes the defect. The availability of these new attribute values may trigger other rules resulting in computation of other defect vector attribute values, and so on.

This mechanism may be used to determine features of map defects including types of operations that are needed to fix the defect, for example, making phone calls, searching through databases, performing internet searches and the like. For example, there may be specific databases of information available to fix defects for specific physical locations. The feature extractor 230 may determine that a defect is associated with missing information that is typically available in a database. For example, a defect type may be a missing telephone number, and the telephone number may be obtainable from a white pages database. In an embodiment, the defect is associated with a type indicating the type of information that may be missing or incorrect. The feature extractor 230 includes a set of rules that determine the types of actions that need to be performed to fix a defect. A rule maps the type of a defect and attributes describing the defect to actions that need to be performed for fixing the defect. For example, given a defect indicating a missing telephone number, a rule may map the defect to a type of action required for fixing the defect based. The rule may be based on a location associated with the defect. A particular rule may map a defect with a type indicating a missing telephone number for a business in a particular location to a task of looking up the telephone number in a yellow pages database specific to that location. Another rule may map defects of a type indicating missing telephone numbers for a business in a different location (e.g., one in which yellow pages data is unavailable or unreliable) to a task of making phone calls to determine the telephone number of the business. The feature extractor 230 stores rules and other information indicating actions that need to be performed for fixing defects of a given type, for example, making phone calls, performing internet searches, performing database lookups etc. In an embodiment, the feature extractor 230 represents the various actions to be performed to fix a defect as a vector. The defect may be represented by a vector of binary values, such that the i^{th} position in the vector corresponds to a particular type of action and the value stored in the i^{th} position determines whether the action needs to be performed for the defect or not, where a zero indicates that the corresponding action does not have to be performed and a one indicates that the corresponding action needs to be performed in order to fix the defect. As an example, in a defect vector (1,0,1,0,0,1), the first position of the vector has value 1 indicating the defect requires making a phone call, the second position has value 0 indicating the defect does not require performing internet searches, the third position is 1 indicating the defect requires searching in a particular database, and so on. In an embodiment, the vector representing the defect may include real values, for example, to represent various factors associated with the defect, for example, a language associated with the defect, a region of the map in which the defect occurred, and the like.

As another example, the feature extractor 230 may determine that a given defect requires making a phone call to a certain region where a particular language is typically spoken. Accordingly, the feature extractor may infer that fixing this defect requires knowledge of that particular language. The feature extractor 230 may also be able to determine that phone calls to a particular physical location associated with a map defect may be made only during particular hours and accordingly the defect should be assigned to an operator who works in a particular shift. The feature extractor 230 may determine that a defect is associated with web pages or uniform resource locators (URLs) of web pages, and that fixing such defects requires expertise with extracting information from the internet.

The feature extractor may also determine a priority of a defect that describes a value of the defective map entry. For example, a high priority defect should be considered more important compared to lower priority defects, and should be scheduled for repair sooner rather than later. In an embodiment, the priority is determined as a function of specific attributes describing the defect, for example, the number of times the defect was reported, the region where the business associated with the defect is located, the age of the defect and so on. The priority of a task helps determine the shift in which the task is scheduled.

In an embodiment where a model is determined for a category of operators or an embodiment in which a single model is used for all the operators, the feature extractor extracts the features of operators from a profile of each operator stored in the operator profile store 340. Features of operators include expertise at particular types of actions, shift availability, and fluency in a particular language. Other features of operators may include educational qualifications, age, ethnicity, work location, performance evaluations and so on.

The feature extractor 230 may extract information from various sources including the map defect store 315 and the history log 320. Some features are extracted once for each map defect and are stored in the feature store 345, for example, characteristics of a business listing associated with the defect. Other features may be periodically extracted and updated, for example, features that change over time. A feature may change over time, for example, if an operator updates, adds, or deletes an attribute value. The various features of the defect that are extracted are used as inputs for machine learning.

The task scheduler 110 schedules tasks associated with fixing defects. Scheduling a task may comprise determining a particular shift during which a map defect is targeted to be fixed by an operator. The task scheduler 110 further comprises an operator model 360, task assignment module 365, and task store 370. The task scheduler 110 identifies map defects stored in the map defects store 315 that are ready to be fixed and creates a task. The task scheduler 110 stores information describing the task in the task store 370, including the map defect being fixed, an operator assigned for fixing the task (if assigned), and a state of the task indicating whether the task has been assigned to an operator, whether the task is pending or completed.

The operator model 360 provides an estimate of time taken by a particular operator for a given task. In an embodiment, an operator model is created for each operator, using the machine learning methods described above. Thus, for example, if there are three shifts of operators, and each shift has ten operators available to fix defects, there will be thirty operator models. Given a map defect and an operator, the operator model 360 for the operator is identified and applied to the map defect to predict the completion time for the map defect by the operator. Alternatively, a single operator model 360 can be constructed, in which case the operator model 360 takes a map defect and an operator identifier as an input and predicts the completion time for the map defect by the operator. The model may also be configured to receive as input the available shifts for scheduling a task and then to associate tasks with specific shifts. For example, tasks that require making phone calls are associated with shifts that correspond to working hours of the target region to which the call is made.

The task assignment module 365 takes a set of tasks and a set of operators identified as working during a time period and assigns the tasks to the operators so as to maximize the number of tasks completed during the time period. The techniques described herein ensure that the set of operators for a given period are utilized to their optimal potential.

In an embodiment, the task assignment is modeled as a generalize assignment problem. The generalized assignment problem takes as input n items x₁ through xₙ and m kinds of bins, b₁ through bₘ. Each item xⱼ is associated with a “profit” pᵢⱼ. For a bin bᵢ, each item xⱼ is associated with a weight wᵢⱼ. The solution to the generalized assignment problem is a subset S of items and an assignment from the subset S to the bins. A feasible solution is a solution in which the sum of weights of assigned items for each bin bᵢ is at most wᵢ. The profit associated with a solution is the sum of profits for each bin-item assignment. The generalized assignment problem aims at finding a feasible solution that maximizes profit. In an embodiment, the task assignment module 365 models the task assignment to operators as a generalized assignment problem in which the profit pᵢⱼ is set to one for all tasks. The tasks correspond to the items x₁ through xₙ and the bins b correspond to the operators. The assignment of items to bins corresponds to assigning tasks to operators for a particular period of time, such as a working shift, or a portion thereof

In some embodiments, the “profit” is the value associated with each task, and can be assigned based on information describing the task, for example, a type of the task, the age of the task, or the priority of the task, or an actual monetary value associated with completing the task. The value of each task can be determined based on other factors as well, for example, a click through rate of a web page associated with the business listing of the task, the number of times the defect specified in the task was reported, the population density of the location of the business associated with the task, or a rate at which the business listing is requested by users. A business with a web page that has a very high click through rate is used by a large number of people and accordingly, defects related to this business may be considered more significant and having a higher value. If a defect is reported a large number of times, it is likely that a large number of people are interested in this physical location or the business and therefore this defect needs to be fixed as soon as possible. If a business listing is requested very frequently by people, defects related to this business listing should be considered high priority. Defects related to locations that are heavily populated, for example, Manhattan should be considered higher priority than defects related to businesses located in areas with very low population, for example, a small isolated town with a population of few thousand people.

Higher priority tasks should be assigned to earlier shifts since they correspond to higher profit and the generalized assignment problem aims at maximizing profit. If a task stays unprocessed for a long time, the profit value associated with the task may be increased to increase the chances that the task is soon assigned to an operator. In an embodiment the profit associated with each item is assigned the same value, for example, one. The resulting task assignment as a result aims at maximizing the number of tasks completed during a shift, since all tasks are assumed to be equally important. In an embodiment, wᵢ is mapped to the total time period (the entire shift) and is mapped to the time taken by operator i to process issue j, and a feasible solution corresponds to assignments of tasks to operators so that the operators can finish the assigned tasks during a shift.

### Training of Operator Models

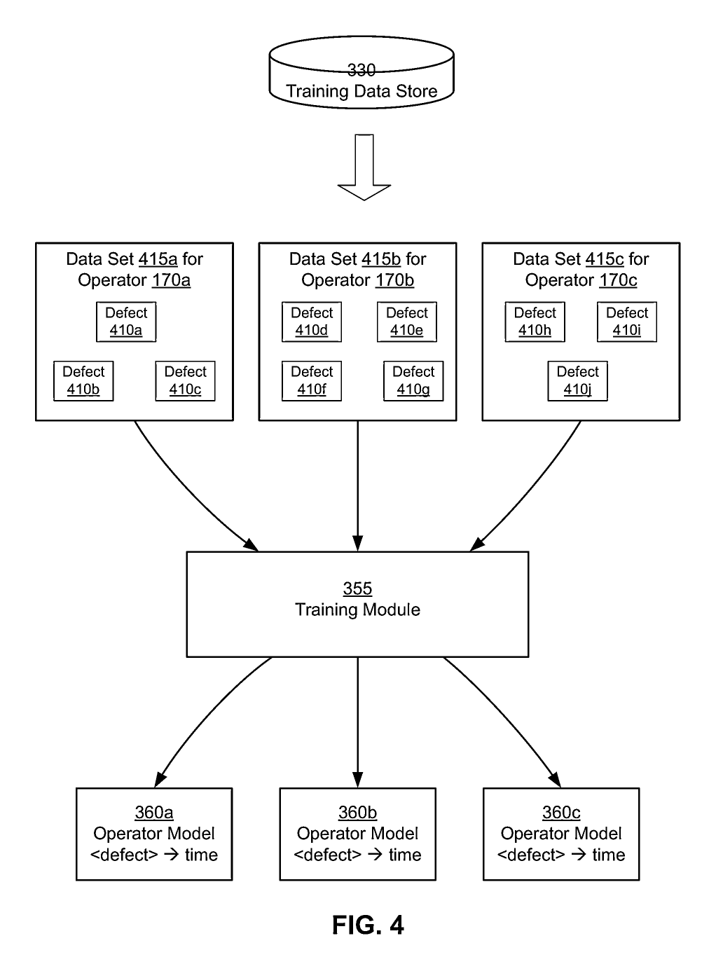

FIG. 4 shows a data flow diagram illustrating the data flow for training operator models for predicting completion time for tasks, according to one embodiment of the invention. The training data store 330 stores training data sets comprising defects previously fixed by each operator. For example, as shown in FIG. 4, data set 415a comprises defects 410a, 410b, 410c previously fixed by operator 170a; data set 415b comprises defects 410d, 410e, 410f, 410g previously fixed by operator 170b; and data set 415c comprises defects 410h, 410i, 410j previously fixed by operator 170c.

Each data set 415 corresponding to an operator 170 comprises defects that that operator worked on to correct. For example, each data set 415 corresponding to an operator 170 may include defects in which a phone number was corrected, defects in which a mistake in the business name was corrected, defects that required the operator to perform internet searches, defects that required the operator to make phone calls, defects that were fixed during different shifts (day shift, evening shift, and night shift), and so on.

In an embodiment, the task scheduler allows each operator to either accept or reject an assigned task. If an operator rejects a task, the training module 355 assigns a very large value to the time taken by the operator to complete the task, thereby indicating that the operator is not interested in taking tasks of that particular type. As a result, an operator model 360 trained using the training data predicts a large completion time for that particular type of task, so that tasks of that particular type are not likely to be assigned to the operator by the task scheduler.

The training module 355 generates a machine learning model for each operator based on the operator's respective data set. Based on the training, operator models 360a, 360b, 360c are generated for the operators 170a, 170b, and 170c respectively. Each operator model 360 predicts the expected completion time for a given defect by the corresponding operator. For example, given a defect 410, operator model 360a predicts the expected time taken by operator 170a to fix the defect 410, operator model 360b predicts the expected time taken by operator 170b to fix the defect 410, and operator model 360c predicts the expected time taken by operator 170c to fix the defect 410. In general, an operator model 360 can be developed to predict expected completion time for any type of task, for example, quality testing, trouble shooting, or delivery of certain item.

### Job Scheduling

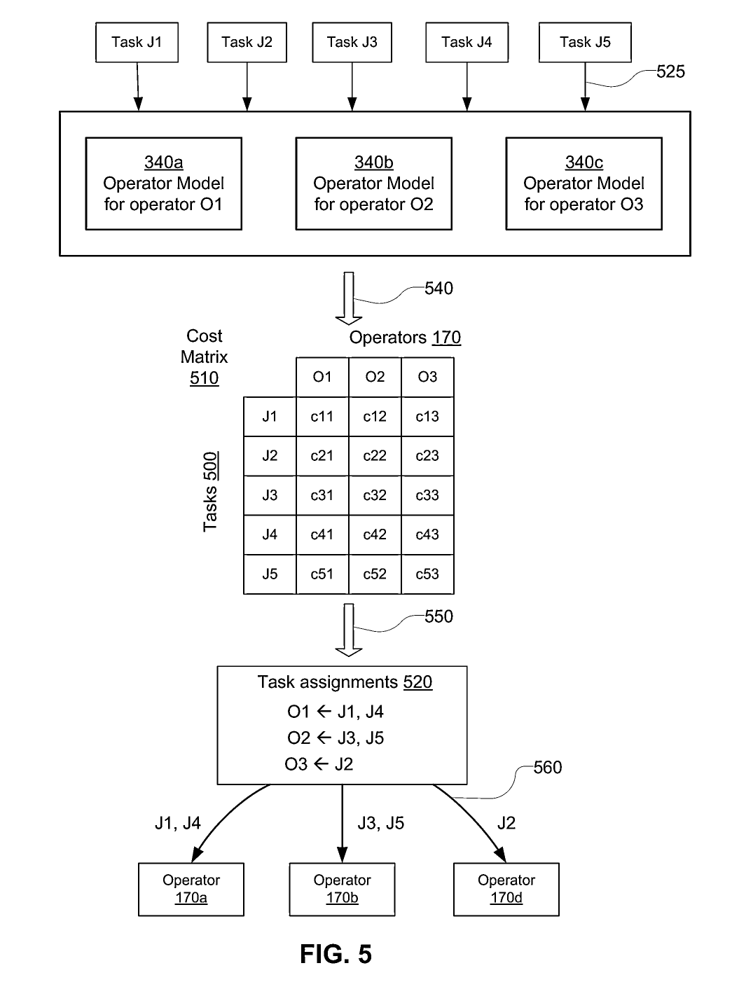

FIG. 5 shows a data flow diagram illustrating the interaction between various types of data stored in the mapping system for assigning tasks to operators, according to one embodiment of the invention. As illustrated in FIG. 5, pending tasks J1, J2, J3, J4, and J5 are being assigned to operators O1, O2, and O3 respectively who plan to work during a particular shift. Furthermore, the assignment is for completion of the tasks by the operators during the shift. The number of input tasks can be much larger than the total number of tasks that can be performed by the operators in a given shift. Accordingly, a subset of the pending tasks is assigned to the operators for execution during the shift and remaining tasks are analyzed for assignment during subsequent shifts to a possibly different set of operators. Furthermore, the input set of tasks can keep changing, for example, as new tasks are added. The features describing tasks J1, J2, J3, J4, and J5 are input 525 to the operator models 340a, 340b, 340c corresponding to operators O1, O2, and O3 respectively. Each task description is input 525 to each operator model 340 to determine the predicted time of completion of the task by the corresponding operator 170.

The task scheduler 110 generates a cost matrix 510 mapping tasks 500 to operators 170. Each entry of the cost matrix 510 corresponds to a cost estimate associated with the completion of task 500 by the operator 170, where the cost is the amount of time required by the operators to complete the task. For example, cost estimate of completing task J1 by operator O1 is C11, cost estimate of completing task J2 by operator O1 is C21, cost estimate of completing task J3 by operator O2 is C32, and so on.

The task assignment module 365 uses the cost matrix 510 to assign 550 tasks to each operator. As described herein, the task assignment module 365 formulates a generalized assignment problem corresponding to the tasks, and the operators. The task assignment module 365 may assign a profit value for each task or assume a profit value of 1 for each task. As used herein, the profit value for a task is a measure of the relative importance of the task as described above. If a profit value is assigned to each task, the task assignment module 365 maximizes the total profit for all task assignments. If the profit value is the same for all tasks (e.g., 1), then the task assignment module 365 effectively maximizes the number of tasks completed during the time period. The solution to the generalized assignment problem provides a mapping from the tasks to each operator. As illustrated in FIG. 5, operator O1 is assigned tasks J1 and J4, operator O2 is assigned tasks J3 and J5, and operator O3 is assigned task J2. Typically, the number of tasks and operators can be very large, for example, the number of tasks can be several thousands and the number of operators can be hundreds. Therefore, the cost matrix 510 has a large number of entries. The information describing the tasks assigned to each operator is sent 560 to the respective operator 170. The process shown in FIG. 5 may be repeated for each shift.

A new task created and stored in the task store 370 may initially have an “unassigned” status. When the task is assigned to an operator, the status of the task may be changed to “assigned.” A task with an “unassigned” or “assigned” status is a pending task. If an operator completes a task, the status of the task may be changed to “completed.” If the predicted time for a task is too small compared to the actual time needed by the operator to complete the task, the operator may not be able to finish all the tasks assigned to the operator for a shift. The status of the assigned tasks that are left incomplete at the end of the shift may be changed back to “unassigned” so that the task gets reassigned for a future shift.

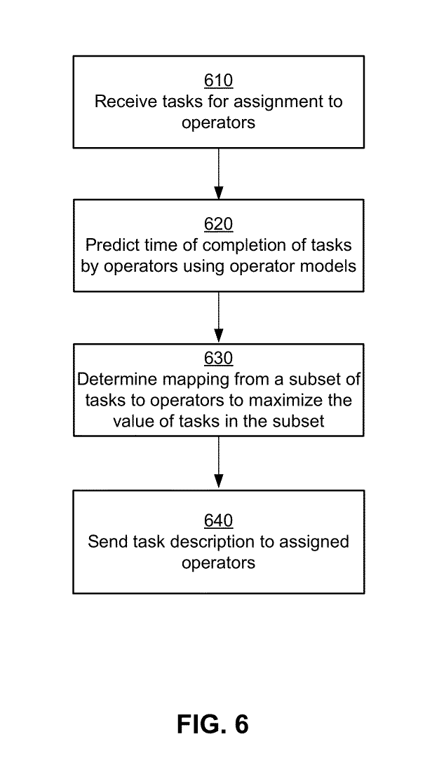

FIG. 6 shows a flowchart illustrating the process of assigning tasks to operators, according to one embodiment of the invention. As shown in the flowchart, the task scheduler 110 receives a set of pending tasks 500 for assigning to operators 170 for a given shift. Each task may be associated with a value, for example, a value indicating a significance or priority of the task (n.b., the value of a task is a measure of its profit). The task scheduler 110 uses the operator models 340 to predict the time (n.b., the time to complete a task is a measure of its cost) taken by each operator for each task. This provides the task scheduler 110 with a cost matrix that includes the cost of each task if performed by an operator. The task assignment module 365 determines 630 a mapping from a subset of tasks to the operators that maximizes the value associated with completing the subset of tasks. In an embodiment, if the value of each task is same, for example, one, the mapping maximizes the number of tasks performed during a shift. The task assignment module 365 sends 640 the description of the assigned tasks to each operator 170. In an embodiment, the tasks assigned to each operator can be viewed by each operator in a user interface, for example, the user interface illustrated in FIG. 2. The status of the tasks assigned is changed to a value “assigned.” If there are any tasks that remain incomplete at the end of the shift, the status of these tasks is changed back to “unassigned” and the tasks are added to the set of pending tasks and the process repeats the steps 610, 620, 630, and 640 to assign at least a subset of all unassigned tasks to the operators starting the new shift. In an embodiment, information indicating any partial completion of the task is added to the task description. For example, if a task requires both internet search and searches among various databases and only the internet searches are completed by an operator but not the database searches, this information is stored with the task. The operator models 360 utilize this updated information for predicting the time taken to complete the remaining portions of the task by operators of another shift.

The methods and systems described herein can be used for other problems that require assignment of tasks to operators. For example, a large software business may have software bugs that are fixed by programmers. Each bug can be described by a set of features, such as the type of bug, the system or product in which it occurs, the language that the software is developed in, and so forth. The software business may use the techniques described herein to assign software bugs to programmers to fix them in a particular release cycle or other period. As another example, a technical organization may receive technical support tasks that are resolved by technical support persons. Each technical support task will have a set of features that describe the task, such as its location, system, type, and so forth. The techniques disclosed herein can be used to assign technical support tasks to technical support personnel for completion during a shift.

### Computer Architecture

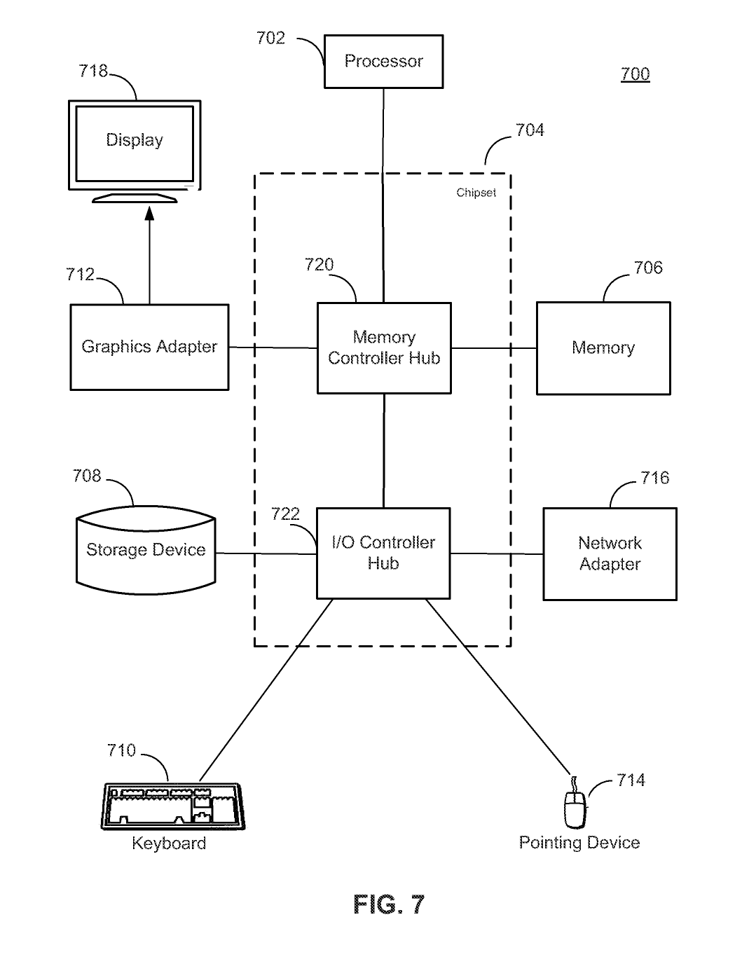

FIG. 7 is a high-level block diagram illustrating an example computer 700, such as a computer running the mapping system 100 shown in FIG. 1. The computer 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

The storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, or other type of pointing device, and is used in combination with the keyboard 710 to input data into the computer system 700. The graphics adapter 712 displays images and other information on the display 718. The network adapter 716 couples the computer system 700 to one or more computer networks.

The computer 700 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 708, loaded into the memory 706, and executed by the processor 702.

The types of computers 700 used can vary depending upon the embodiment and requirements. For example, a computer system used for a mapping system 100 might include one or more blade computers lacking displays, keyboards, and/or other devices shown in FIG. 7. Likewise, a computer system used as a client device 105 might comprise a mobile phone or other such device with a touch-sensitive display and limited processing power.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having,” “by,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for assigning tasks to operators. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A method performed by a computer system for assigning tasks to operators, the method comprising:
receiving by the computer system a set of pending tasks and a set of operators for performing tasks in a work shift, wherein the tasks comprise actions for fixing defects in map data displayed by an online mapping system, wherein a defect is associated with a business listing displayable on a map;
for each pending task associated with a defect, determining a value of the task based on user interactions associated with the business listing of the defect;
for each pending task, predicting by the computer an amount of time required by each operator to complete the task, using a model trained from historical data describing tasks previously completed by members of the set of operators;
determining by the computer system, a subset of the pending tasks to be performed during the work shift and a mapping from the subset of the pending tasks to operators, each task associated with an operator for performing the task during the work shift, so as to maximize a total value of the subset of tasks;
assigning tasks to the associated operators for completion during the work shift based on the mapping; and
storing in the computer system information identifying the assigned tasks and the associated operators.

2. The computer implemented method of claim 1, wherein the value of each task is determined based on priority with which the task needs to be resolved.

3. (canceled)

4. The computer implemented method of claim 1, wherein the value of each task is determined based on a click through rate of a web page associated with the business listing.

5. The computer implemented method of claim 1, wherein the value of each task is determined based on a number of times the defect was reported.

6. The computer implemented method of claim 1, wherein the value of each task is determined based on a location of the business.

7. The computer implemented method of claim 6, wherein the value of a task associated with a business listing in a heavily populated location is higher than a value of a task associated with a business listing in a less populated location.

8. The computer implemented method of claim 1, wherein the value of each task is determined based on a number of times the business listing is requested by users.

9. The computer implemented method of claim 1, wherein a feature of the defect used for training the model comprises a type of information of the business listing determined to be incorrect.

10. The computer implemented method of claim 9, wherein the type of information of the business listing comprises one or more of a phone number, a postal address, a web address, or hours or operation.

11. A computer-implemented system for assigning tasks to operators, the system comprising:
one or more computer processors; and
one or more non-transitory computer-readable storage mediums storing computer program modules configured to execute on the one or more computer processors, the computer program modules comprising at least:
a task scheduler module configured to:
receive a set of pending tasks and a set of operators for performing tasks in a work shift, wherein the tasks comprise actions for fixing defects in map data displayed by an online mapping system, wherein a defect is associated with a business listing displayable on a map;
for each pending task associated with a defect, determine a value of the task based on user interactions associated with the business listing of the defect;
an operator model configured to:
predict an amount of time required by each operator to complete each pending task, the operator model trained using historical data describing tasks previously completed by members of the set of operators;
a task assignment model configured to:
determine a subset of the pending tasks to be performed during the work shift and a mapping from the subset of the pending tasks to operators, each task associated with an operator for performing the task during the work shift, so as to maximize a total value of the subset of tasks;
assign tasks to the associated operators for completion during the work shift based on the mapping; and
store in the computer system information identifying the assigned tasks and the associated operators.

12. (canceled)

13. The computer implemented system of claim 11, wherein the value of each task is determined based on a significance score of the business associated with the defect.

14. The computer implemented system of claim 11, wherein a feature of the defect used for training the model comprises a type of information of the business listing determined to be incorrect.

15. The computer implemented system of claim 14, wherein the type of information of the business listing comprises one or more of a phone number, a postal address, a web address, or hours or operation.

16. A computer program product having a non-transitory computer-readable storage medium storing computer-executable code for assigning tasks to operators, the code comprising:
a task scheduler module configured to:
receive a set of pending tasks and a set of operators for performing tasks in a work shift, wherein the tasks comprise actions for fixing defects in map data displayed by an online mapping system, wherein a defect is associated with a business listing displayable on a map;
for each pending task associated with a defect, determine a value of the task based on user interactions associated with the business listing of the defect;
an operator model configured to:
for each pending task, predict an amount of time required by each operator to complete the task, the operator model trained using historical data describing tasks previously completed by members of the set of operators;
a task assignment model configured to:
determine a subset of the pending tasks to be performed during the work shift and a mapping from the subset of the pending tasks to operators, each task associated with an operator for performing the task during the work shift, so as to maximize a total value of the subset of tasks;
assign tasks to the associated operators for completion during the work shift based on the mapping; and
store in the computer system information identifying the assigned tasks and the associated operators.

17. (canceled)

18. The computer program product of claim 16, wherein the value of each task is determined based on a significance score of the business associated with the defect.

19. The computer program product of claim 16, wherein a feature of the defect used for training the model comprises a type of information of the business listing determined to be incorrect.

20. The computer program product of claim 19, wherein the type of information of the business listing comprises one or more of a phone number, a postal address, a web address, or hours or operation.

21. The computer program product of claim 16, wherein the value of each task is determined based on a click through rate of a web page associated with the business listing.

22. The computer program product of claim 16, wherein the value of each task is determined based on a number of times the defect was reported.

23. The computer program product of claim 16, wherein the value of each task is determined based on a number of times the business listing is requested by users.
